(19) United States
(12) Patent Application Publication
(10) Pub. No.: US 2025/0362906 A1
(43) Pub. Date: Nov. 27, 2025

(54) DISCOVERY PLATFORM FOR MODERNIZATION OF LEGACY PROGRAM CODE

(71) Applicant: Ionate, Inc., San Francisco, CA (US)

(72) Inventors: Ajanta Adhikari, San Francisco, CA (US); Amol Dharmadhikari, San Francisco, CA (US); Sujatha Kasturirangan, San Francisco, CA (US)

(21) Appl. No.: 19/219,179

(22) Filed: May 27, 2025

Related U.S. Application Data
(60) Provisional application No. 63/651,862, filed on May 24, 2024.

(51) Int. Cl. G06F 8/76

(52) U.S. Cl. CPC G06F 8/76

(57) ABSTRACT

Methods and systems for improving modernization of legacy software using an intelligent discovery platform are described herein. A client-based agent may generate metadata regarding the received legacy software. The code metadata may be analyzed by a code classifier module, which computes a plurality of score factors from the metrics from the legacy software metadata using a knowledge base from a modernization platform. The classified code metadata may be used by a project-specific model to derive a plurality of sub-scores based on the plurality of score factors associated with the legacy software. An analytics engine may then identify a code module from the legacy software having a greatest derived vulnerability score factor. A graphical interface including reconstructed code, corresponding modern code, and an explanation of vulnerabilities may then be generated by the analytics and reporting component for the identified code module.

### RELATED APPLICATIONS

This application claims the benefit of U.S. Provisional Application No. 63/651,862, filed May 24, 2024, which is incorporated herein in its entirety.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In a number of industries, old and/or obsolete software continues to be relied upon to provide critical functionality. Such legacy software is often still in use due to difficulties in adapting the software to modern network software environments and/or unsuitability of modern equivalents. There can be tremendous difficulty in adapting code to function on modern network-based architectures. Not only have methods of coding changed since the release of legacy software, but analogous functionality in modern programming languages may output different results than their legacy equivalents.

### SUMMARY

Methods and systems for improving modernization of legacy software using an intelligent discovery platform are described herein. One or more agent components of the platform may be used to generate metadata regarding the received legacy software. The metadata may include code metadata, log metadata, database metadata, and infrastructure metadata, where code metadata includes a plurality of metrics describing a size, underlying file types, and underlying technologies used by the legacy software. The code metadata may be analyzed by a code classifier machine learning module, which computes a plurality of score factors from the metrics from the legacy software metadata using a knowledge base from a modernization platform. The knowledge base may include an accumulation of data generated from modernizing legacy software including similar code metadata to the code metadata of the received legacy software. The code classifier machine learning module may be trained to use predetermined score factors assigned to previously-performed software modernizations performed on software having different sizes, underlying file types, and underlying technologies.

The classified code metadata of the received legacy software may be used to compute a plurality of score factors associated with the legacy software, based on the received metadata in response to receiving the metadata regarding the legacy software. The score factors may then be transmitted to a project-specific model of an analytics and reporting component (which may be a separate machine learning module). The score factors may be used by the project-specific model to derive a plurality of sub-scores based on the plurality of score factors associated with the legacy software, the plurality of sub-scores including sub-scores for composition, complexity, dependency, vulnerability, and portability. The analytics and reporting component may then identify a code module from the legacy software having a greatest derived vulnerability score factor relative to other code modules. Both a reconstructed representational snippet of original code and corresponding modern code may be generated based on metadata associated with the identified code module. The analytics and reporting component may then generate a graphical interface including the reconstructed representational snippet, the generated modern code, and an automatically-generated explanation of vulnerabilities identified by the analytics and reporting component for the identified code module. In some embodiments, the classified code metadata may be used to generate an assessment report that includes an assessment score. The assessment score may be a cumulative metric that is based on the separate sub-metrics generated by the analytics engine.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates an example discovery system for improving legacy software modernization, in an embodiment.

FIG. 2 illustrates an example discovery system for legacy software modernization that generates a knowledge base usable in the system for determining a plurality of modernization parameters, in an embodiment.

FIG. 3 illustrates an example discovery system for legacy software modernization that classifies log data using a log analysis component, in an embodiment.

FIG. 4 is an operational flow diagram illustrating a high-level overview of a method for identifying and resolving modernization challenges within legacy software, in an embodiment.

FIG. 5 is an operational flow diagram illustrating a high-level overview of a method for generating a vulnerability interface presenting a representative code module, identified problem areas within the code module, and solutions to the identified problems, in an embodiment.

FIG. 6 illustrates a vulnerability interface including reconstructed legacy code and generated modern code corresponding to a legacy code module, in an embodiment.

FIG. 7 illustrates a vulnerability interface including output of executed legacy code and modern code corresponding to a legacy code module, in an embodiment.

FIG. 8 illustrates vulnerability interface including reconstructed legacy code and augmented modern code, in an embodiment.

FIG. 9 illustrates a vulnerability interface including output of executed legacy code and augmented modern code corresponding to a legacy code module, in an embodiment.

FIG. 10 illustrates an expanded explanation of detected vulnerabilities within a legacy code module, in an embodiment.

FIG. 11 illustrates a displayable report interface for a plurality of determined modernization parameters, in an embodiment.

FIGS. 12A-12B illustrate composition interfaces describing composition factors of legacy software, in an embodiment.

FIG. 13 illustrates a complexity interface describing complexity scores and factors related to the scores for a plurality of code modules of legacy software, in an embodiment.

FIG. 14 illustrates a complexity interface showing individual metrics for a particular code module, in an embodiment.

FIG. 15 illustrates an interactive flow diagram for a particular code module, in an embodiment.

FIGS. 16A-16B illustrate interactive dependency graphs for code modules of an exemplary legacy software, in an embodiment.

FIG. 17 illustrates an interactive dependency graph for code modules, including unused modules, of an exemplary legacy software, in an embodiment.

FIG. 18 illustrates an exemplary modernization plan derived using determined modernization parameters, in an embodiment.

FIG. 19 depicts a block diagram illustrating an exemplary computing system for execution of the operations comprising various embodiments of the disclosure.

### DETAILED DESCRIPTION

The described intelligent discovery platform (e.g., IONATE® SOTERIA, provided by Ionate, Inc. of San Francisco, California) provides a multi-faceted assessment of any legacy application, software system, or product. The intelligent discovery platform shows what is present in the legacy software system and how to modernize it. Identifying vulnerabilities in the business logic & rules, the intelligent discovery platform shows how the applications and software work together as a whole. It also identifies and detects with increased intelligence the technologies that make up the various components of the entire software system (including the legacy and modern components) and produces a high-level assessment report.

The intelligent discovery platform may combine all aspects of its assessment into a single score summarizing the effectiveness of the prospective conversion from legacy software to modern software. The assessment score may express a summary of the different facets of the software project from the perspective of modernization. The assessment score may be based on any suitable combination of: composition, complexity, dependency, vulnerability, and portability of the legacy software.

Any of the embodiments described herein may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

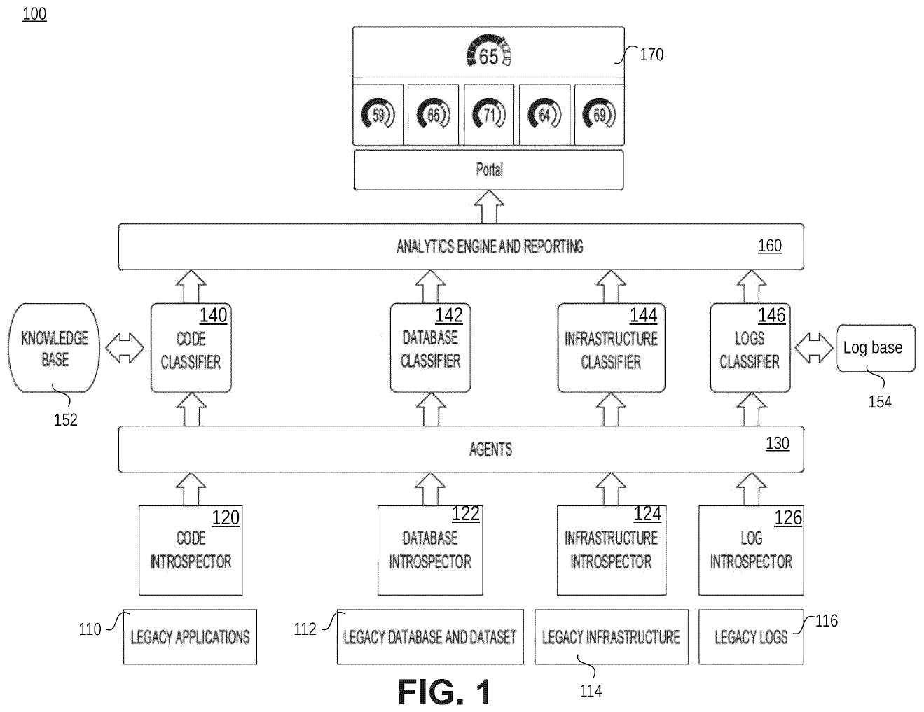

FIG. 1 illustrates an example discovery system 100 for improving legacy software modernization, in an embodiment. The described intelligent discovery platform 100 may take the form of a multi-component application that performs the functions of collecting metadata for software projects, databases and infrastructure, and creating a detailed report 170 highlighting modernization pathways and risks. The intelligent discovery platform may work in conjunction with a multi-technology artificial intelligence-based application modernization platform (“modernization platform”) that uses machine learning (e.g., IONATE® APPDATE) to assess, analyze, and score the target software application based on both metadata that is gathered by one or more agents 130 and assimilated knowledge base 152 from the modernization platform, derived from having modernized multiple applications of different types and technologies.

The intelligent discovery platform taps into and uses the knowledge base 152 of the separate modernization platform, querying the knowledge base using internal APIs while performing modernization risk assessment of the software projects. More concretely, the intelligent discovery platform 100 first parses the metadata received from the agents 130, creating an internal model of the software project codebase being evaluated that is optimized to highlight the modernization aspects of the software project. The discovery platform 100 may then use various criteria to analyze and evaluate the target codebase using the collected metadata. Based on the criteria, a multi-dimensional, project-specific model may be created to output sub-scores assessing various aspects of the modernization. The project-specific model may then be progressively improved by removing artifacts from the calculation and further enriched by using the knowledge base from the modernization platform to get the final sub-scores included in the cumulative report.

FIG. 1 illustrates flow of information, classification and analytics to create a cumulative modernization report 170. The intelligent discovery platform 100 may be implemented as a multi-component application that includes at least the three components. First, agents 130 may represent a standalone software agent that can be run on-premises in customer networks and datacenters. The purpose of this module is to gather metadata about software projects, databases and infrastructure in a non-intrusive manner. The metadata is then uploaded to the customer portal and for report generation. Second, the network-based portal (not shown) may include a multi-tenant SaaS application that provides a portal for clients to perform various activities for assessing their legacy applications. Clients can create scans, upload their scan metadata (after running the Agent), request for report generation and view the reports in the portal. Third, the analytics and reporting component 160 may be a backend component that uses the metadata collected by the agents 130, and additional intelligence and generates a cumulative report 170 for each modernization project that can be accessed and viewed via the network portal.

A typical customer environment which is needed for running a software application is a mix of software code artifacts, infrastructure components and other runtime artifacts. To obtain more accurate information, both static and dynamic, the Agents component 130 may be modularized into the below sub-modules that help in gathering metadata on specific code or infrastructure components as needed:
Code Introspector 120: This module performs introspection of Software projects and code artifacts, scanning them and gathering the information in a metadata database. This module can parse and handle multiple programming languages, platforms, build systems and other static artifacts that go towards making a software project.
Database Introspector 122: This module performs introspection of the database systems that the software projects use. The relational models in the database systems are critical to the workings of any software project because they capture and crystallize the business relationships between the various entities. The Database introspector is able to handle multiple types of database systems such as Oracle, MySQL, IBM DB2, PostGreSQL a well as more flexible NoSQL systems such as MongoDB and Apache Cassandra.
Infrastructure Introspector 124: The infrastructure on which software applications run have significant information on the runtime characteristics of the software application. The Infrastructure Introspector parses the runtime aspects of the infrastructure such as the hardware characteristics, virtual machine configuration, file system details, memory, CPU, network configuration and other such details.
Log Introspector 126: The runtime logs of an application have valuable information that can be used to determine runtime or dynamic dependencies, program affinity and other code flow characteristics of the application. The Log inspector parses logfiles from multiple runtime logs such as the webserver logs, access logs, application mid-tier logs, UI logs etc. Using these log files, the Log inspector extracts significant details about the application runtime which are used by Soteria to determine characteristics of the modernized application, such as the number (and content) of the microservices, co-location vs separate project.

Agents 130 may be provided to the client system to interact and collect metadata regarding the legacy software to be modernized. The code introspector 120 sub-agent may collect metadata from legacy applications 110 of the legacy software. The applications may include mainframe-like applications, middleware monolithic applications, and desktop applications. Mainframe-like applications may include midrange server software implemented in different flavors of COBOL such as: Unisys® software (provided by Unisys Corporation of Blue Bell, Pennsylvania, USA), Fujitsu software (provided by Fujitsu Limited of Kanagawa, Japan), or Micro Focus software (provided by Micro Focus International plc of Newbury, England). Other mainframe applications may include software written in COBOL, COBOL-adjacent languages, Natural (provided by Software AG of Darmstadt, Germany), or Report Program Generator (RPG) (provided by provided by International Business Machines Corporation of Armonk, New York, USA) programming languages, for example. Middleware monolithic applications may include IBM Integration Bus (IIB®) (provided by International Business Machines Corporation of Armonk, New York, USA), Business Process Manager (BPM) software, service-oriented architecture (SOA) software, and any software written in a conventional monolithic programming language (e.g., Java® provided by Sun Microsystems, Inc. of Palo Alto, California, USA,.NET® provided by Microsoft Corporation of Redmond, Washington, USA, or PHP provided by SAN-EI Kagaku Co., Ltd. Of Toyko, Japan, etc.). Desktop applications the code introspector 120 may analyze may include database software (e.g., Oracle® Forms (provided by Oracle International Corporation of Redwood, California, USA) or Microsoft Visual Basic (“Visual Basic”) (provided by Microsoft Corporation of Redmond, Washington, USA), software written using PowerBuilder (provided by Appeon Inc. of San Francisco, California, USA) or a similar development tool, or other legacy programming languages such as Delphi (provided by Embarcadero Technologies, Inc. of Austin, Texas, USA) or Centura (provided by Daegis Inc. of Irving, Texas, USA), for example.

As stated above, the code introspector 120 sub-agent obtains metadata regarding the legacy applications 110 executing on the client system. Common metadata collected by the code introspector 120 may include:
Lines of Code;
Blank lines of Code;
Comment lines of Code;
File size;
File type;
File extension;
File hash;
Extended file metadata; and
Project metadata.

In addition to the general code-related metadata described above, certain software technologies may be better assessed using additional metadata custom-selected for the software technology in question. For example, when the introspector 120 recognizes that the legacy applications include code modules written in COBOL, additional metadata collected may include:
Dialect;
Number of variables of different types;
Number of different syntactic elements (performs, redefines, gotos, copy-replacing, computes etc.);
Paragraph metadata;
Paragraph call metadata (code call graph);
External referenced copybooks, DCLGENs, called programs, Cics DCLGENs;
EXEC SQL metadata;
EXEC CICS metadata; and
Dialect specific information.

In another example, when the legacy applications are written in Java, the code introspector 120 may retrieve the following additional metadata:
Java version;
External build dependencies (compile time and run time);
Number of different syntactic elements (methods, variables, loops, lambdas, inner classes etc.);
Inheritance information (super class, interfaces);
External dependencies for a java class;
Static Code graph;
Inheritance graph; and
Dynamic call metadata.

Similarly to code introspector 120, the database introspector 122 may generate metadata from different databases and datasets 112 used by the legacy software. For example, legacy datasets (e.g., VSAM, ADABAS, UNISYS DBS-II, etc.) and relational databases (e.g., DB2, SQL server, MYSQL, Oracle databases, POSTGRS, etc.) 112 may each be parsed to generate metadata for the metadata classifier. An infrastructure introspector 124 may generate metadata regarding various architectural components 114 used by the legacy software in some embodiments. For example, UNIX-based operating system servers, Windows-based operating system servers, and network equipment may be identified and documented by the infrastructure introspector 124. Furthermore, the log introspector 126 may generate log metadata from application logs, access logs, or any other text-based logs 116 used by the received legacy software. While examples of each component for which metadata may be generated are listed above, the sub-agents are not limited to these examples, and may generate metadata from any software components of the received legacy software when it may inform the classification of the legacy software.

Then, once the metadata has been generated by the agents (and sub-agents), the machine-learning classifiers may each classify the received metadata for analysis by the analytics engine 160. The metadata may be received from the agents 130 running on the client systems by any suitable technique. For example, an online portal (e.g., a website, or back-end accessed using a software API) may be used that receives the legacy software metadata automatically by communicating with the agents 130 over a network connection. Alternatively, a user could manually upload the metadata gathered by the agents 130 using the online portal.

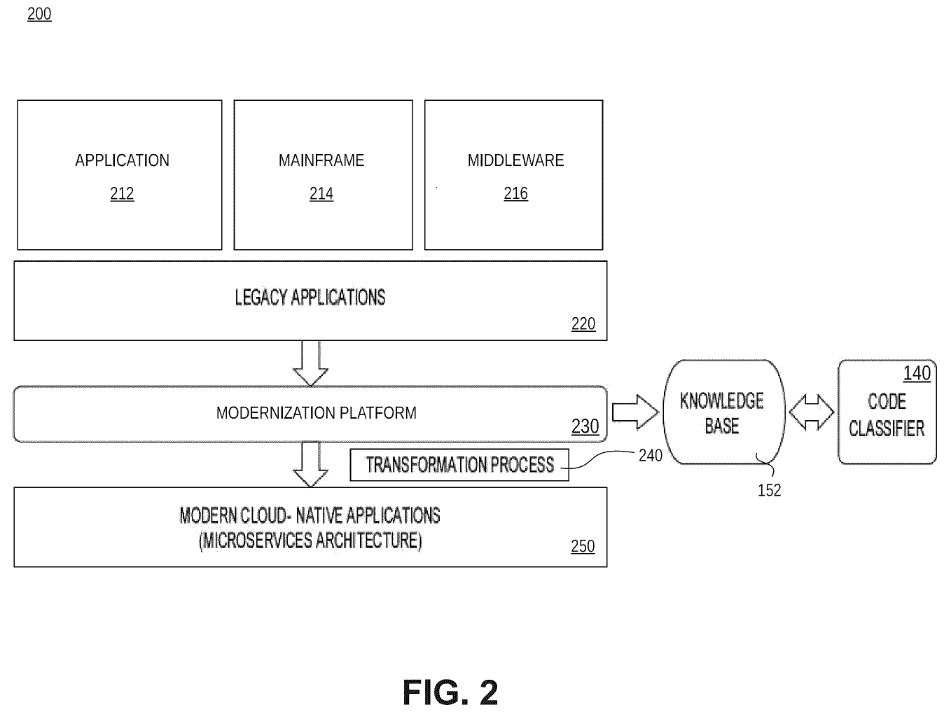

Each classifier may be a machine learning model trained to automatically generate analytics based on the received metadata. For example, after receiving the metadata, the code classifier 140 may utilize the knowledge base 152 of a modernization platform (shown in FIG. 2) to classify metadata generated from the code of the legacy software. The code classifier 140 module may include semantic information and logical knowledge graphs about the metadata generated from the source code of the legacy software. The code classifier may process legacy code modules by:
classifying the various source codes into file types, indicative of the programming language or technology that is used;
identifying the business functionality and business rules in the programs;
identifying the data structures and logic in the programs;
recognizing potential security vulnerability patterns in the programs; and
identifying compliance violations, business vulnerabilities and hotspots in the programs.

Each of the above-noted aspects of the code may be associated with a specific fingerprint in the code is encapsulated by the information in the metadata of the legacy code. The code classifier 140 may have the capability to perform basic classification decisions regarding the above parameters based on the patterns that are found in the legacy software metadata. However, for more sophisticated metadata patterns, the code classifier 140 queries the knowledge base 152 of the modernization platform. Once the classification of the source code is performed, the resulting information may be fed back into the knowledge base 152 to improve the efficiency and accuracy of classification of source code for legacy software in the future.

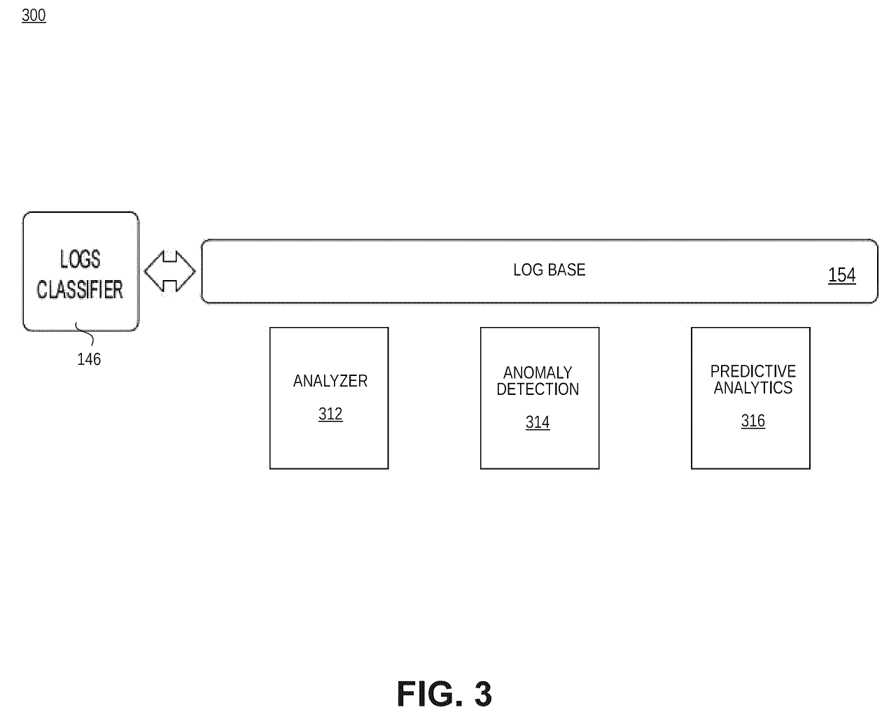

Likewise, the log classifier 146 may classify the metadata generated from the log introspector 126 using a log parser and knowledge base 154, which is elaborated upon in FIG. 3. Finally, the database classifier 142 and the infrastructure classifier 144 may utilize machine learning models to classify any metadata received regarding databases and infrastructure respectively. The classified metadata may be transmitted to the analytics and reporting engine 160 to generate a report 170 on the modernization of the legacy software, including the cumulative assessment score and sub-scores used to generate the cumulative score. The report interface may be transmitted to a user via web portal, for example, and is discussed in greater detail below.

FIG. 2 illustrates an example platform 200 for legacy software modernization that generates the knowledge base 152 used by code classifier 140 to generate a plurality of modernization parameters, in an embodiment. The modernization platform 230, together with the intelligent discovery platform described herein, is able to perform modernization of a wide range of legacy applications 220 such as:
Monolithic applications 216: WebLogic applications, WebSphere applications, PHP, JSP/Servlets,.NET Applications, IBM IIB, IBM BPM,SOA, etc.;
Mainframe/Mid-Range Applications 214: COBOL, RPG, NATURAL-ADABAS
   various flavors and platforms (e.g. IBM, Microfocus, Fujitsu, Unisys); and/or
Thick client-server applications 212 (Desktop Applications): Visual Basic, Oracle Forms, Delphi, Power Builder etc.

The resultant modernized applications 250 may be true cloud-native, containerized microservices using Java®, SpringBoot® (provided by Broadcom Inc., of Palo Alto, California) or .NET Core platforms and can run using a cloud orchestration engine like Kubernetes. During the modernization process 240, the modernization platform may use a comprehensive machine learning model trained with metadata and patterns, both from the legacy code as well as the transformed code. As a result, the modernization platform 230 may have over time assimilated an enormous knowledge base of different code samples, programming constructs, usage patterns, potential vulnerabilities from the vast amount of code that has been transformed. Additionally, since the modernization platform 230 has performed the transformation of the aforementioned codebases, it also has knowledge about the problems that may arise when modernizing code from different sources/languages, and the correct way of transforming the code to a modern platform.

FIG. 3 illustrates an exemplary log parser 154 for legacy software modernization that classifies log data using a log analysis component 312, in an embodiment. Log parser 154 may be an exemplary predictive analytics platform that uses log metadata to identify anomalies and make predictions regarding modernization from the log metadata (e.g., Mentive, provided by Ionate). The textual log data may be provided to log classifier 146, which may be a trained machine learning model trained to identify patterns from historic log data. The log machine learning model 146, trained to know what data is expected in the log data from the legacy software, is able to both identify anomalies in the received log data (using log anomaly data 314) and forecast what future log data should be (using predictive analytics data 316).

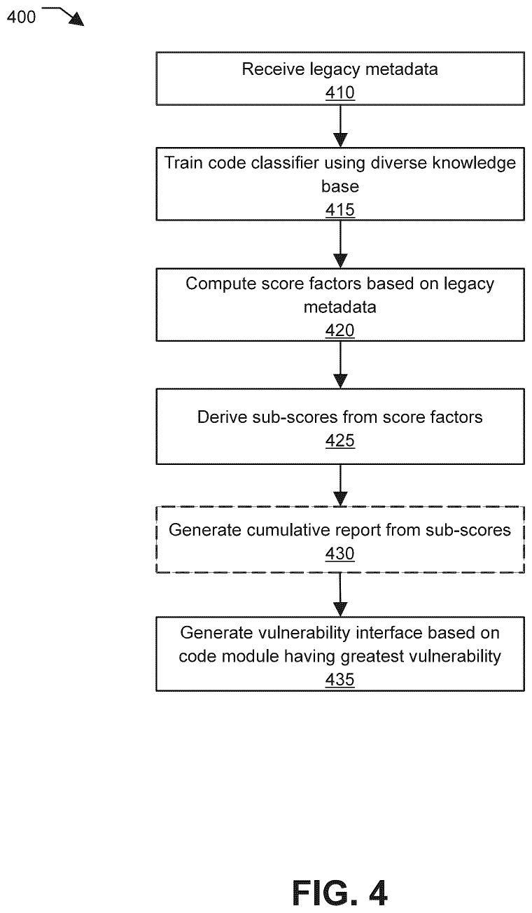

FIG. 4 is an operational flow diagram illustrating a high-level overview of a method 400 for identifying and resolving modernization challenges within legacy software, in an embodiment. One or more agent components of the platform may be used to generate metadata regarding the received legacy software on the client system, as described above. The metadata may include code metadata, log metadata, database metadata, and infrastructure metadata, where code metadata includes a plurality of metrics describing a size, underlying file types, and underlying technologies used by the legacy software. At step 410 the metadata may be received by the intelligent discovery platform, where it is analyzed by at least a code classifier machine learning module.

The code classifier machine learning module may be trained to use predetermined score factors assigned to previously-performed software modernizations performed on software having different sizes, underlying file types, and underlying technologies at step 415. The received code metadata may then be analyzed by the code classifier machine learning module, which computes a plurality of score factors from the metrics within the legacy software metadata using a knowledge base from a modernization platform. The knowledge base may include an accumulation of data generated from modernizing legacy software including similar code metadata to the code metadata of the received legacy software.

The classified code metadata of the received legacy software, including the score factors, may be transmitted to an analytics and reporting component, which may be a separate machine learning module. The analytics and reporting component may include a project-specific mathematical model that computes a plurality of score factors associated with the legacy software in response to receiving the classified metadata regarding the legacy software. The project-specific mathematical model may be created by the discovery platform using the specific metadata for the project under question. This customized model may be implemented as a machine learning model that combines semantic information about the source code with logical knowledge graphs. In an exemplary embodiment, the project-specific model may be implemented as a graph-based module that uses specific techniques from graph-based knowledge representation to create a project specific model. The raw metadata collected by the code classifier module may be input to the project-specific model directly, and the project-specific model may output sub-scores for the legacy software. Every project is unique with its combination of programming languages, technologies, specific usage patterns and dependencies. A project-specific model may incorporate many facets of the legacy software source code, such as:
semantic relationships between legacy software components based on numerous criteria (direct dependency, transitive dependency, functional class, runtime execution characteristics, etc.);
dynamic aspects of the execution of the code modules; and
capturing and surfacing hidden ontologies of the legacy software source code and components.

Semantic information from the metadata used by the project-specific model may include specific data structure patterns that are used in the code, representations of business rules and logic in the code, a high-level call graph of the methods in a program describing the operational semantics of the program, a runtime program invocation tree for various use cases describing the execution patterns of the system as a whole, and/or database interaction patterns of the different programs (if any). The project-specific model may be optimized for highlighting and deriving emergent project code structure and categorization. Additionally, the project-specific model is refined to capture latent vulnerabilities and their depth in the legacy software codebase.

The project-specific mathematical model may then derive a plurality of sub-scores based on the plurality of score factors and the classified metadata associated with the legacy software at step 425. The plurality of sub-scores may include sub-scores for at least complexity, dependency, and vulnerability, with further embodiments including sub-scores for composition and portability of the legacy software. As noted above, the project-specific model may be implemented as a graph augmented and enriched with semantic and ontological information about the legacy software codebase. The actual score calculation may be performed based on the computational graph. The structure of the graph and the inter-relationship between the nodes may capture the modernization aspects of the project codebase. During actual score calculation, the project-specific model is then used to create a computational graph that has numerical scores associated with each node. The numerical scores may capture different modernization aspects of the project components, as well their relationships

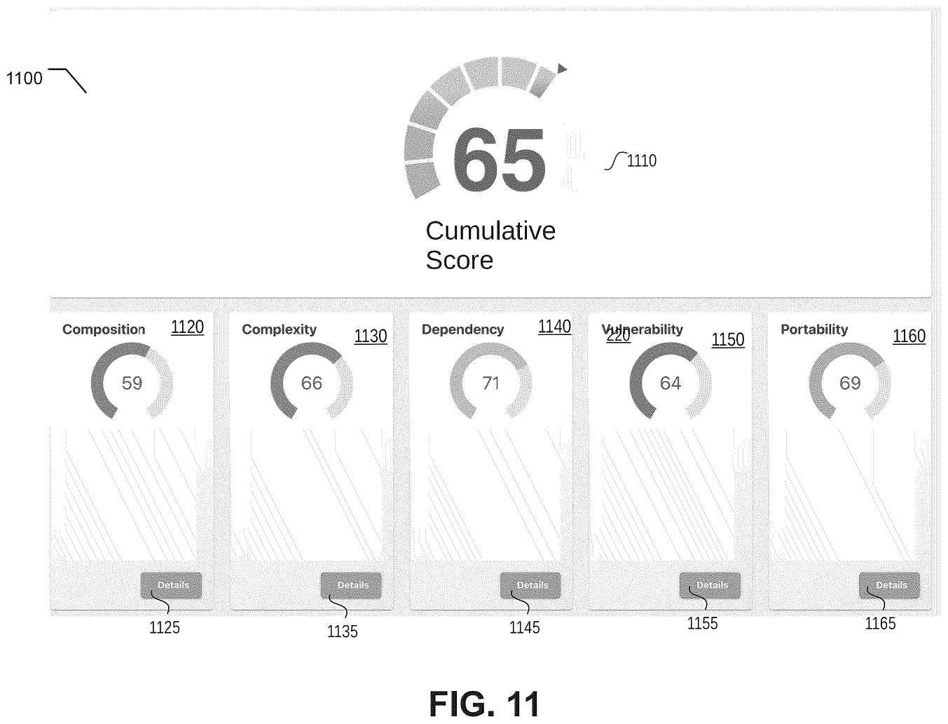

After the sub-scores have been generated, in some embodiments a feedback loop to the knowledge base 152 may be utilized, where metadata associated with classified code modules of the source code of the legacy software is returned to the knowledge base 152. Providing new metadata and the corresponding classification may help ensure that the modernization platform 230 is continuously trained on all the patterns encountered by the intelligent discovery platform. The plurality of sub-scores may optionally be included in an assessment report that includes a cumulative assessment score at step 430. The assessment score may be a cumulative metric that is based on the separate sub-scores generated by the project-specific mathematical model. The details of the sub-scores and assessment report are discussed below in greater detail, in the discussion of FIG. 11.

To facilitate the modernization process, the analytics and reporting component may generate a vulnerability interface identifying a code module of the legacy software having a greatest vulnerability score factor, and present solutions to the code issues causing the code module to have the greatest vulnerability score factor at step 435. Identifying significant vulnerabilities of the legacy code and resolving them at the discovery stage improves the modernization process by allowing accurate forecasting of how long the modernization process will take, and identifying which code modules will require more testing due to likelihood of problems, among other benefits. Legacy programming languages like COBOL may include the feature to create very customized data types with respect to type, precision, signedness and storage. Such data types may not cleanly map to the types in modern languages, and may cause many vulnerabilities (i.e. discrepancies between the modern code and the original source code) in calculations using modern code. The metadata that the code inspector 120 collects from the legacy source code may include all the unique data types that are present in the legacy source code, as well as the formulae and calculations in which the variables of those types are used. This metadata may be used by the intelligent discovery platform to identify code modules at the discovery phase that may create vulnerabilities, advantageously informing the modernization process.

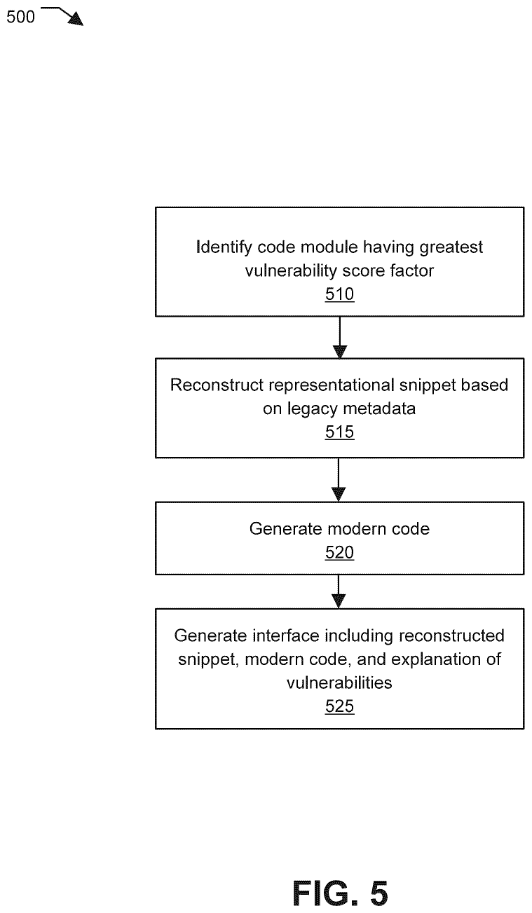

FIG. 5 is an operational flow diagram illustrating a high-level overview of a method 500 for generating a vulnerability interface (e.g., the vulnerability interface generated at step 435 of method 400) presenting a representative code module, identified problem areas within the code module, and solutions to the identified problems, in an embodiment. At step 510, the analytics and reporting component may identify a code module from the legacy software having a greatest derived vulnerability score factor relative to other code modules. A reconstructed representational snippet of original code may be generated at step 515 based on metadata associated with the identified code module. Each code module of the legacy software may have metadata representing the syntax tree of the code module, which has been generated by the agent without including any proprietary information specific to the client associated with the legacy software.

The metadata representation of the syntax tree of the code module may be used by the analytics and reporting component, trained using the knowledge base from the modernization platform, to reconstruct the a representational snippet of original code from the metadata representation at step 515. The reconstructed representational snippet may be substantially similar to the legacy code from which the metadata representation was generated by the agent.

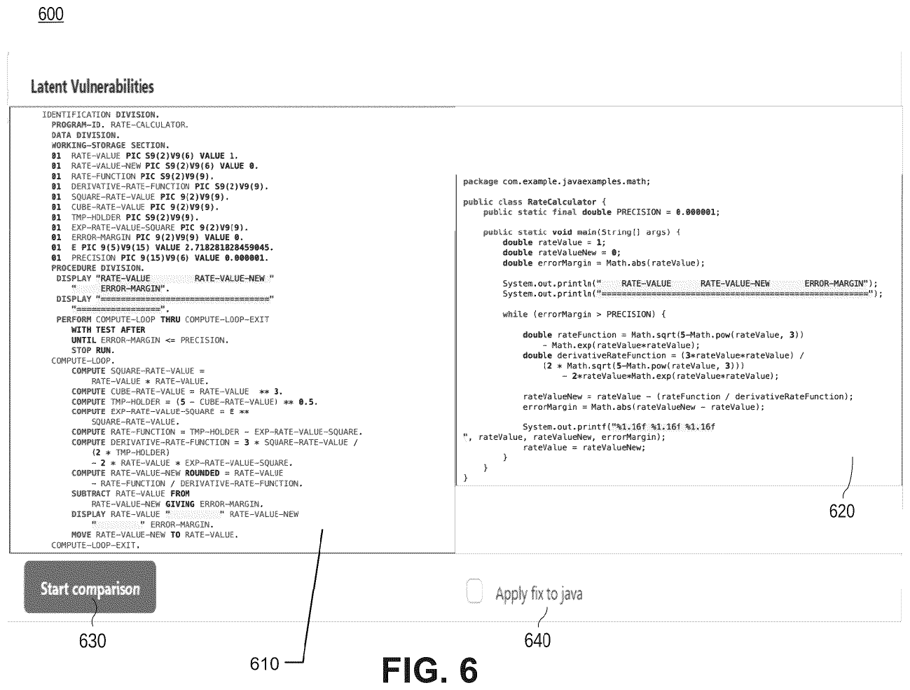

The analytics and reporting component may then also use the metadata representation of the syntax of the code module to generate modern code corresponding to the identified code module at step 520, without any knowledge or reference to the customer code. The analytics and reporting component may then generate a graphical interface including the reconstructed representational snippet, the generated modern code, and an automatically-generated explanation of vulnerabilities identified by the analytics and reporting component for the identified code module at step 525. FIG. 6 illustrates a vulnerability interface 600 including reconstructed legacy code 610 and generated modern code 620 corresponding to a legacy code module, in an embodiment. Vulnerability interface 600 also provides a user-selectable link 630 to execute both the reconstructed representational snippet 610 of the identified code module and the modern code 620 corresponding to the reconstructed snippet to show how the vulnerabilities of the code module may lead to errors with modernization. Vulnerability interface 600 may also include a selectable option to repair the generated modern code 620 to improve performance of the generated modern code, in terms of accurately reproducing the performance of the reconstructed snippet of the identified code module.

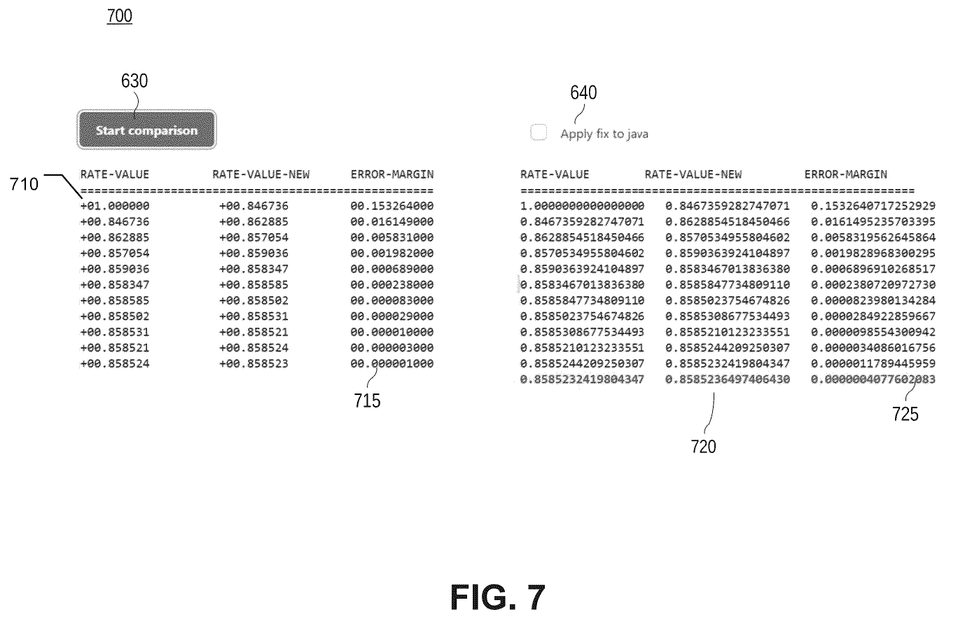

FIG. 7 illustrates a vulnerability interface 700 including output of executed legacy code 610 and modern code 620 corresponding to a legacy code module, in an embodiment. In some embodiments, vulnerability interface 700 may be part of the same vulnerability interface 600, and may be accessed by simply scrolling down the page. Element 710 illustrates the result of executing reconstructed snippet 610 eleven times starting with a rate value of 1.0. After the 11th run of the reconstructed snippet 610, the error value 715 is determined to be 0.000001. By contrast, when the generated modern code is executed twelve times, the error value 725 of the twelfth iteration is a very different value. Such differences, brought on by different methods of calculation in the different languages used for legacy code 610 and modern code 620, may lead to significant discrepancies in performance if not addressed during the modernization process.

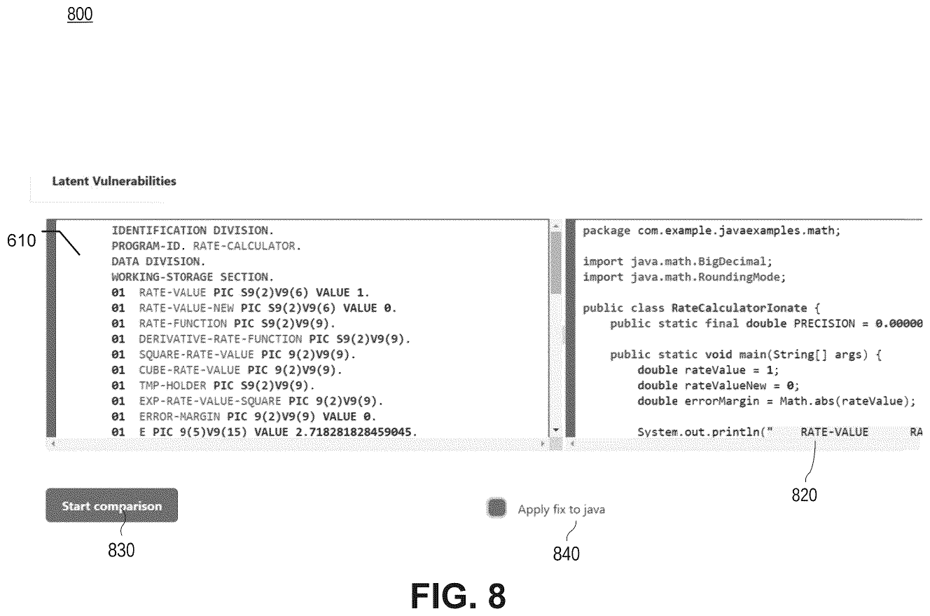

FIG. 8 illustrates vulnerability interface 800 including reconstructed legacy code and augmented modern code, in an embodiment. In interface 800, a user has selected selectable option to repair the generated modern code 840 to improve performance of the generated modern code, automatically generating a request to fix the generated modern code (e.g., in response to viewing the different results displayed in interface 700). In response to receiving the selection of the option 840, the analytics and reporting component may request an augmented version of the generated modern code from the modernization platform that is modified to account for differences between the legacy software and modern software platforms detected during the classification of the metadata of the legacy software. After receiving the augmented version of the generated modern code, the generated modern code may be replaced with the augmented version 820, which contains modified code compared to original generated modern code 620. A user may then select link 830 to separately execute both the reconstructed representational snippet 610 of the identified code module and the augmented version of the modern code 820 corresponding to the reconstructed snippet 610.

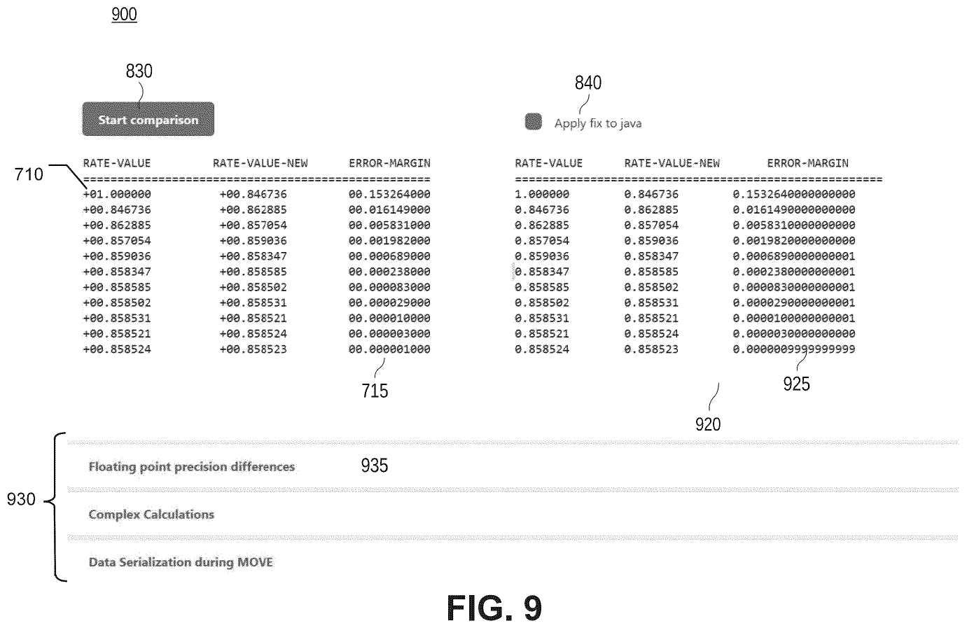

In response to the second request to execute the displayed code, the vulnerability interface 900 of FIG. 9, including outputs of executed legacy code 710 and augmented modern code 920 corresponding to the identified legacy code module, may be displayed. As seen in interface 900, the outputs are more similar than the original outputs generated by the representational snippet and the generated modern code (as seen in FIG. 7). The error of the eleventh iteration of the representational snippet 715 is 0.000001, while the error of the eleventh iteration of the augmented version of the generated modern code 925 is substantially equivalent to the value 715 produced by the representational snippet. Furthermore, interface 900 includes automatically generated explanations 930 for the vulnerabilities detected in the identified code module.

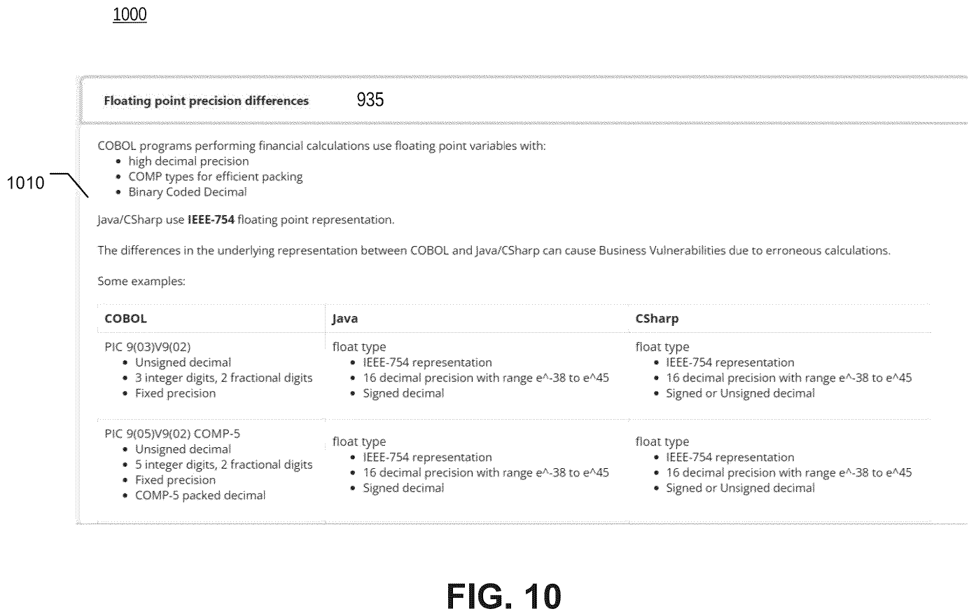

Each detected vulnerability may receive its own explanation on the vulnerability interface 900. FIG. 10 illustrates an interface 1000 including an expanded explanation 1010 of a floating point precision differences vulnerability 935 detected within a legacy code module, in an embodiment. Each expanded explanation may be created dynamically depending on what exact vulnerabilities are detected in the identified legacy code module. For example, there are two COBOL data types being shown in expanded explanation 1010: PIC 9(03)V9(02) and PIC 9(05)V9(02) COMP-5. These two types are specific to the identified legacy code module and are used in some calculations which can potentially lead to vulnerabilities when the legacy code is converted to modern code. Accordingly, the explanation 1010 is specific to the identified legacy code module.

As noted above, at step 430 further interfaces may be generated by the intelligent discovery platform as part of a cumulative report for the modernization of the analyzed legacy software. FIG. 11 illustrates a displayable report interface 1100 for a plurality of determined modernization parameters, in an embodiment. The cumulative assessment score 1110 may be derived using proprietary technology that assigns a single score to a modernization project based on a confluence of factors including those discussed in greater detail below. As discussed above, the assessment score 1110 may be generated by the analytics and reporting engine, a machine learning-based model that includes parameters for each of the five below-described categories.

The Composition 1120 sub-score may provide a bird's eye view of all the different components of the software project. The source code of a typical legacy software system or project includes many artifacts. For example, the source code, which incorporates the business functionality of the project's purpose, can be implemented in multiple languages in legacy software, and can be a combination of backend source code, middle-tier source code, UI source code and database source code. There may also be runtime configuration artifacts, such as properties files, XMLs, YAML files, which are used by the software project during runtime and are used to configure various aspects of the runtime behavior of the product. Furthermore, there may also be XML, JSON, Docker files which are not part of the actual legacy software, but were used to build the legacy software. The build files may specify build dependencies between the various components of the legacy software, and may pull in external dependencies.

The composition sub-score 1120 is not just a summary of the inventory of the software project in many embodiments, but is a score that factors in the aggregate risk of the project based on the artifacts of its legacy code. Projects having a more-or-less uniform composition, or which are using a single programming language or technology have a relatively lesser composition risk as compared to projects that are hybrid UI-backend projects, or using multiple technologies. Also, the technologies and specific versions used by the project also affect the composition score. Technology versions that are that are unsupported by modern software, either due to the legacy software no longer receiving updates and/or being obsolete with no analogous products coded using modern software techniques, are likely to increase the composition risk score.

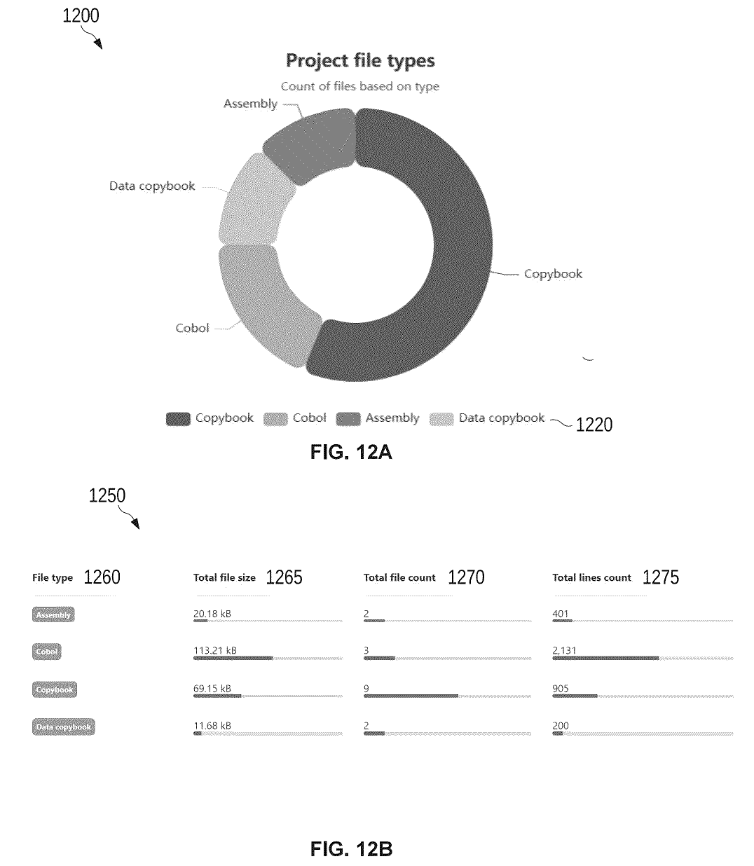

In response to a user selecting link 1125, to elaborate on the composition sub-score 1120, composition interfaces 1200 and 1250 in FIGS. 12A-B may be displayed describing composition factors of legacy software, in an embodiment. Composition interfaces 1200 and 1250 may be part of a single composition interface, or may be presented separately. Interface 1200 illustrates a filterable pie graph allowing a user to filter the pie graph based on file type by selecting various options 1220 corresponding to each file type within the legacy software.

Interface 1250 displays more granular composition score factors identifying how composition sub-score 1120 was determined. In an exemplary embodiment, the composition sub-score may be determined based on any combination of the following inputs:
Number of files in the project 1270;
Sizes of the files in the project 1265;
Unique number of file types (code)—each distinct file type may represent a different technology or programming language that is used in the project;
Unique number of file types (configuration);
Sizes of the files grouped by the file types to get a relative assessment of the volume of the code present in each file type 1275; and
A list of all the technologies used in the project 1260.

A typical list of technologies can include:
Mainframe Projects: SQL, BMS, CICS, COBOL, RPG, PL/I, CL, Assembly, ALGOL
Monolithic Projects: Struts, JMS, EJBs, Servlets, SOAP, PHP, IBM Integration Bus, IBM Mediation Flow, SOA
ThickClient Projects: Visual Basic, PL/SQL, Oracle Forms, Databases, etc.

To determine the composition sub-score in the exemplary embodiment, the above metrics may be provided to the machine learning-based project-specific mathematical model, which combines the metrics to determine a preliminary composition score. The preliminary composition score may then be provided to a second machine-learning artificial intelligence model, which has been trained on legacy modernization projects (having different variations in their technologies) that have been modernized and are associated with an estimated composition score post-modernization generated with the assistance of technicians. Based on the exact composition of the received legacy project, the preliminary composition score may be refined by the second machine learning model to accurately reflect the composition score based on the technology composition.

Returning to FIG. 11, the complexity sub-score 1130 provides a fine-grained score for each artifact in the legacy software based on its complexity. Conventionally there are many software complexity metrics used in the industry, including Halsted metrics, cyclomatic complexity, secular metrics (LOC), and code shape. Most of the above metrics are secular, in the sense that they do not distinguish between different programming languages. The complexity sub-score 1130 may include these conventional metrics as a component, but further implements special techniques to quantify programming language complexity, depending on the underlying source code and the features of the programming language that are used. The complexity sub-score 1130 further incorporates architectural features that are used by the source code under question, addressing the case where there are multiple programming languages that are used in a single program (such as COBOL and SQL).

The complexity score component of the overall assessment score (both of which are derived by the project-specific mathematical model) may be based on the following 5 factors, which are compatible for a wide range of programming languages and technologies:
Base: The base complexity attempts to use secular features such as lines of code, number of commented lines, amount of whitespace and other such indicators to compute the base complexity. The base complexity is weighted by the verboseness of the programming language under question.
Feature: Different programming languages support different features as part of the language itself, which play a role in the complexity of the program under question. The feature complexity measures the program's complexity based on actual features (such as conditions, loops, lambdas, REDEFINES) used in the program. The feature complexity is very specific to the programming language under question and hence is scored differently for different languages.
Structural: All programming languages have evolved to allow intra-program organization for optimal maintainability and readability. This can be in the form of organizing and segregating the program's source code via methods, functions, inner classes, modules etc. Organizing the source code can improve the readability of the source code by ensuring that the programmer can only look at the parts that are of current interest, but the source code's intrinsic complexity increases due cross referencing of the code due to method calls, function calls etc. Structural complexity measures the complexity of the program based on its code shape and structure. Again this is very specific to the programming language under question because different programming languages support different ways of organizing and interlinking their source code. The structural complexity measures the inter-connectedness of the various chunks of source code inside a single program.
Dependency: It is rare that a single program is a complete and standalone in all respects of its functionality. Typical software projects have interdependencies between various programs in their source code. (This is similar to the organization of the source code described in the “Structural” point above, but whereas the “Structural” point above refers to dependencies inside of a program, this refers to inter-program dependencies). The dependencies are of multiple types:
   Inter-program: This refers to the invocation or usage of a program using or calling another program.
   Static: Libraries, which can be internal to the organization or third party
   Dynamic: External programs, utilities, services that can be invoked by any program.

The dependency complexity may measure the complexity of a received legacy software product and be derived based on the static, dynamic and inter-program dependencies.
Architectural: Most enterprise software programs that do anything useful need to access external infrastructure such as files, databases, queues, enterprise buses and use other “platform” services such as concurrency, transaction management. Usage of functionality such as the ones mentioned above make the program more complicated architecturally and is measured by the architectural complexity.
   The overall Complexity score for a source code artifact (such as a COBOL program or a Java class) is a combination of the above 5 factors, combined using any suitable statistical formula.

In an exemplary embodiment, the complexity score for a specific file may be determined by first classifying the file into LOW/MEDIUM/HIGH based on the number of code lines in the file. A base complexity may be determined by first determining the BASE_FACTOR, which is a unique weight/bias that is customer and project-specific and which is derived based on the knowledge base from the model used by the modernization platform. The base_complexity value may then be determined using various metrics such as file size, number of lines, number of code/comment/blank lines. The base_complexity may then be refined by augmenting it with the BASE_FACTOR and normalizing it.

Second, the feature complexity may be determined by determining the base FEATURE_FACTOR, which is a unique weight/bias that is customer and project specific and which is derived based on the knowledge base from the model used by the modernization platform. The feature_complexity is then determined based on the number of different language features used in the file (This is weighted by the complexity of the feature itself. This formula is unique to the language/technology under question.). In some embodiments the feature_complexity value may be refined by augmenting it with the FEATURE_FACTOR and normalizing the result.

Then the structural complexity value may be determined by computing the STRUCT_FACTOR value, which is a unique weight/bias that is customer and project specific and which is derived based on the knowledge base from the model used by the modernization platform. Then the structural_complexity base value may be determined by coming up with a program's internal structure and code call graph. The structural_complexity value is basically the graph complexity of the code's call graph adjusting for various special factors based on the size of the call graph, the adjacency matrix and number of edges of the graph. Finally, in some embodiments the structural_complexity value is refined by augmenting it with the STRUCT_FACTOR and normalizing the result.

The dependency complexity may be similarly determined by obtaining the DEPENDENCY_FACTOR, which is a unique weight/bias that is customer and project specific and which is derived based on the knowledge base from the model used by the modernization platform. The dependency_complexity base value may be determined by identifying a program's external dependencies. A dependency tree of the entire project is created with the current file at its root and the dependency complexity is estimated based on considering dependencies at different depths of the tree. The dependency_complexity may then be optionally refined by augmenting it with the DEPENDENCY_FACTOR and normalizing the result.

Finally, the architectural complexity may be determined, in the exemplary embodiment, determining the ARCHI_FACTOR value, which is a unique weight/bias that is customer and project specific and which is derived based on the knowledge base from the model used by the modernization platform. The architectural_complexity base value is determined by identifying the different technologies that are used in a single program and estimating their architectural complexity. For example, calls to external Webservices (SOAP/REST), Database calls, CICS calls, Batching etc. may be weighted appropriately to come up with the architectural complexity. The architectural_complexity base value may be refined by augmenting it with the ARCHI_FACTOR and normalizing the result of the augmentation.

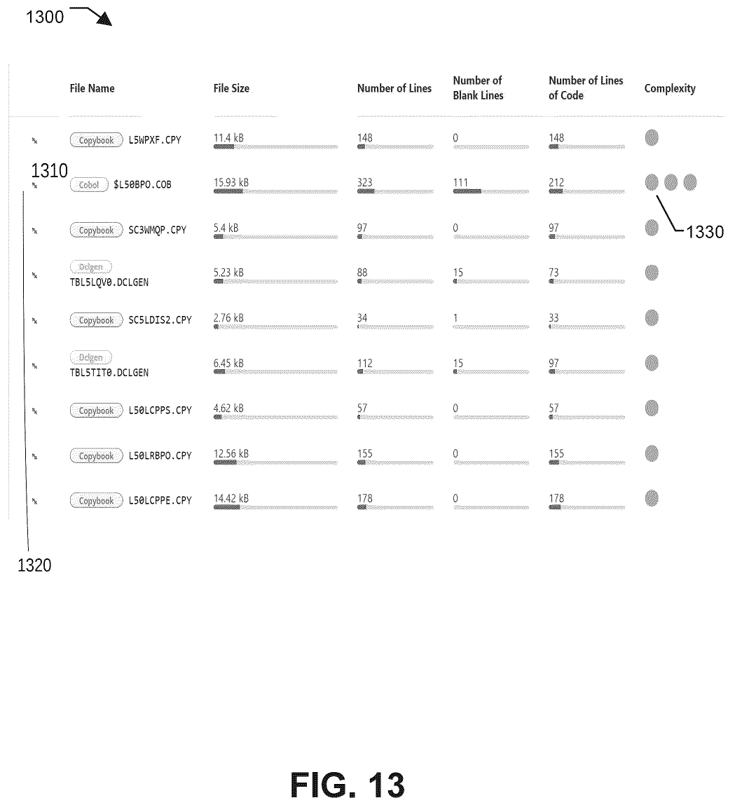

In addition to an overall complexity sub-score 1130, code module or file-specific complexity factors may be determined and presented using the cumulative assessment report. In response to selecting link 1135, complexity interface 1300 in FIG. 13, describing complexity scores and factors related to the scores for a plurality of code modules of legacy software, may be displayed in an embodiment. As seen in interface 1300, factors used to assess file complexity, including file size, number of lines of code, and number of lines within each file, are displayed. Exemplary file 1310 is associated with complexity score factor 1330. Selectable link 1320 allows a user to view even further granular data for the file 1310. The per-file complexity scores in some embodiments are derived from an aggregate score using the five complexity factors and variables listed above. In further embodiments, the overall complexity score for a file may be calculated using the Kolmogorov mean of the individual complexity scores (e.g., the five complexity factors base complexity, feature complexity, structural complexity, architecture complexity, and dependency complexity) by using a custom formula. Individual complexity stores may be passed through a custom function that performs logarithmic scaling of the score to compactify each of the individual complexity scores. The arithmetic mean of the logarithmically-scaled complexity scores may be computed, and the arithmetic mean may be reset to the original scale using the exponential function. The reset arithmetic mean may then be used as the individual file complexity score.

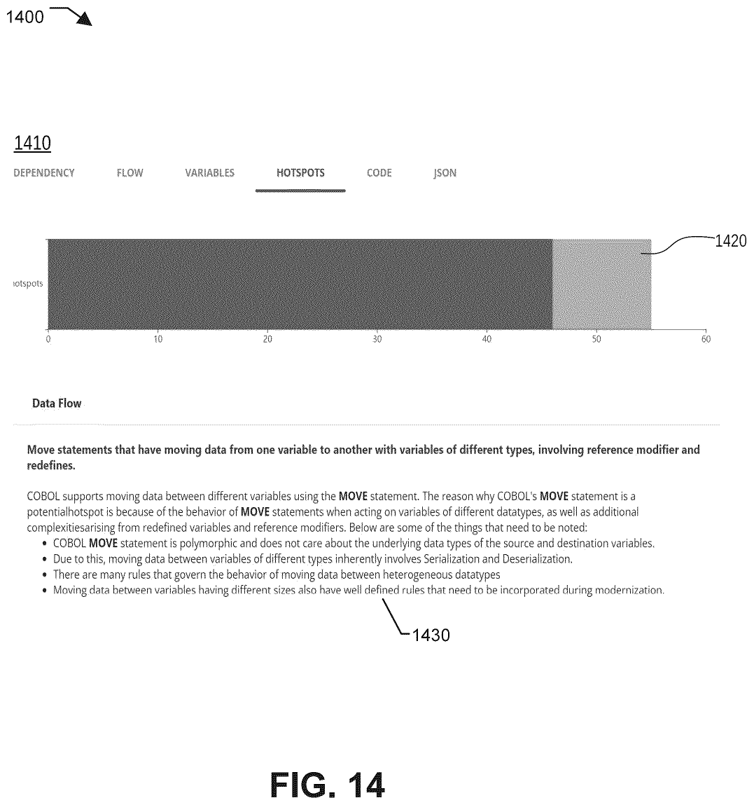

FIG. 14 illustrates a complexity interface 1400 showing individual metrics for a particular code module, in an embodiment, which may be displayed in response to receiving a selection of link 1320. Metrics where more information may be provided via selectable tabs 1410, and may include dependency information for the file 1310 (i.e. which files are called by the file 1310 and what other legacy software files make calls to file 1310) and information regarding the variables used within file 1310. The code and json tabs may provide reconstructed representative snippets of the source code of file 1310 and generated modern code corresponding to the representative snippets, respectively. Bar graph 1420 is associated with the hotspots tab, and illustrates proportionally what types of errors and mismatches with the legacy code may be created in the modernization process of file 1310. Explanation 1430 provides a description of one of the types of hotspots, caused by move statements detected in the file 1310.

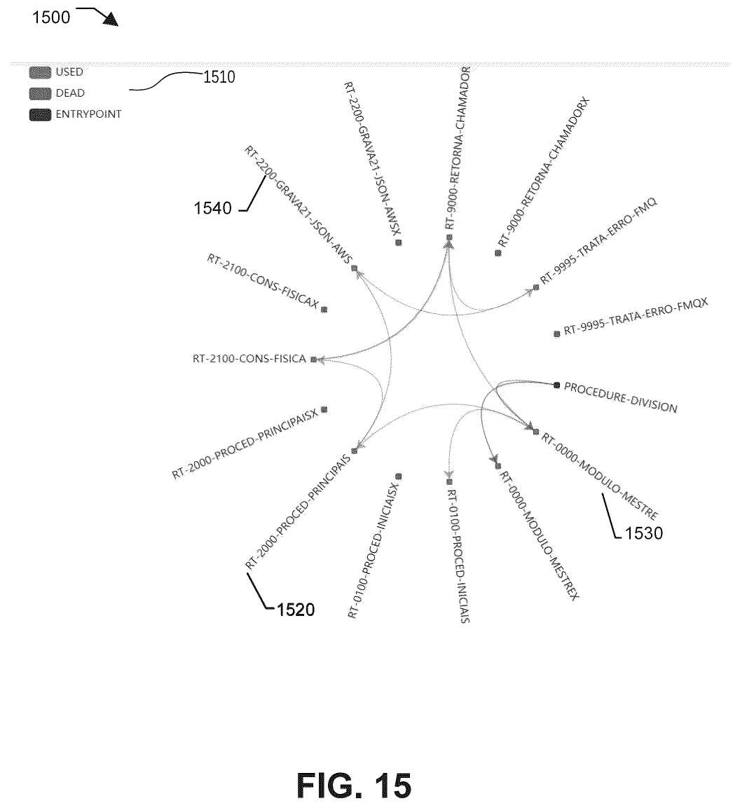

FIG. 15 illustrates an interactive flow diagram 1500 for file 1310, in an embodiment, and may be displayed in response to receiving a selection of the “flow” tab within metrics directory 1410. The interactive diagram 1500 provides a visual representation of how data flows between code modules contained within the file 1310. Legend 1510 allows for filtering of code modules between used code modules, dead code modules (i.e. modules that do not interact with any other module within file 1310), and entrypoint modules (that interact with files external to file 1310). When highlighting individual code modules, a user can visually trace the flow of data. For example, entrypoint module 1530 sends data to module 1520, which in turn exchanges data with module 1540.

Again returning to FIG. 11, the dependency sub-score 1140 highlights both internal dependencies between various modules in the legacy software and their coupling, as well as external dependencies on third-party libraries and APIs. As mentioned in the above section, software programs are rarely standalone and complete, but rely on other programs and libraries. This sort of organization is fundamental to the development of software projects and is instrumental in improving the maintainability and readability of a single program. However, it increases the overall complexity of the software project as a whole. The dependency score component of the overall assessment score measures the complexity of the software project based on the dependencies of the individual programs. In short, the dependency score measures the coupling of the software project between its components as well as with the outside world.

Dependencies can be of multiple types; for example, static dependencies are straightforward dependencies of a program directly invoking another program. In a static dependency, the calling program need not always invoke the well-known entry point of the called program, but may invoke a specific piece of logic embedded in a method. This makes the program dependency more complex and less deterministic and less testable. Dependencies may also be dynamic, where the dependency is not fixed at compile-time. This is a powerful feature of most programming languages because it allows programmers to defer certain decisions to runtime. This also increases the complexity of the project as a while because the programmer needs to handle the error conditions in which the called program cannot be resolved at runtime.

Furthermore, library dependencies are internal, third party or platform libraries which are invoked by any program. Library dependencies are typically static and more predictable because software libraries are typically built to be stateless reusable components which have very deterministic functionality. An example of this is the classes in the Java standard library or the Apache commons library. Finally, external services are dependent on any remote service such as an external Web Service APIs or any RPC services may add further dependency-based challenges.

The dependency sub-score 1140 incorporates all the above types of dependencies, weighing them appropriately based on the modernization angle. Static dependencies imply tighter coupling, which can make the project harder to break down into microservices. Dynamic dependencies can be difficult to detect and increase the dependency complexity as they involve detection of moving parts that can be plugged in at runtime. External service dependencies add to the complexity of modernization if they rely on very old or legacy protocols. Modern platforms may not have support for legacy protocols and hence external service dependencies may need supplier-side or consumer-side wrappers so as to be able to modernize without breaking the application.

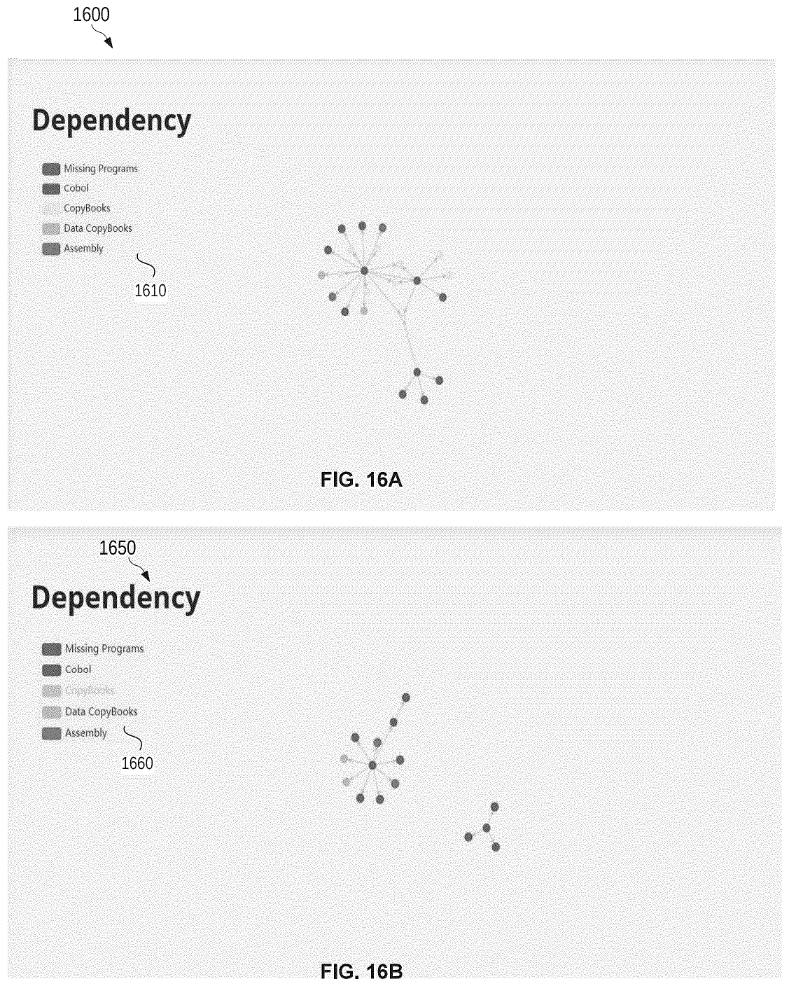

The dependencies between files of the legacy code may be represented as interactive dependency graphs using the cumulative report 1100. In response to selecting link 1145, for example, a dependency graph, such as graphs 1600 and 1650 in FIGS. 16A-B may be generated for code modules of an exemplary legacy software, in an embodiment. Each layer can be inspected, and every file can show its dependencies. Legend 1610 allows for filtering based on file type, which may change the dependency graph entirely. For example, by omitting CopyBooks files in response to user selection of the corresponding option in legend 1610, the dependency graph 1600 is changed to the dependency graph shown in 1650. Each group of linked nodes (each node representing a file) can be independently moved in response to user input, allowing the user to arrange the dependency groups as desired.

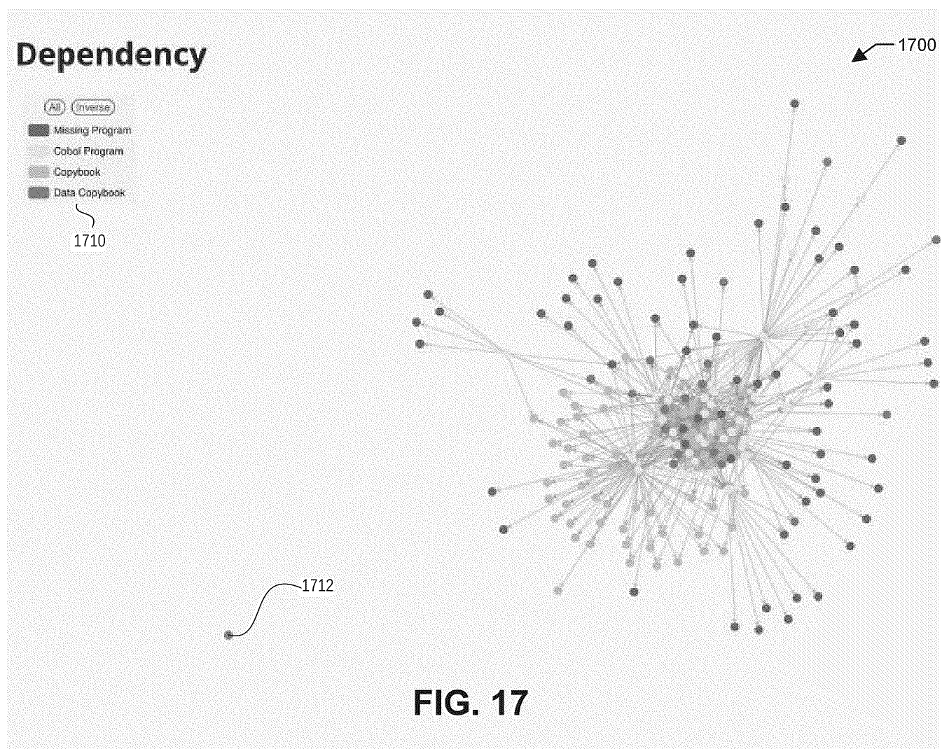

FIG. 17 illustrates another interactive dependency graph for code modules, including unused modules, of an exemplary legacy software, in an embodiment. The above example shows dependencies between the COBOL files Data Files (VSAM) and Data Copy Books. It also highlights missing programs that are required to make this project work, viewable using legend 1710. With this dependency mapping, one can easily figure out dead code (nodes with no edges connected to other nodes, such as node 1712), complexity with modernization, and its dependent components.

Again returning to FIG. 11, a vulnerability is any behavior of a software component or application that can be exploited either intentionally or unintentionally causing either an immediate or gradual failure of the business functionality. Software vulnerabilities are of many classes, including coding vulnerabilities, cybersecurity vulnerabilities published in the CVE database, and vulnerabilities in business logic & rules. Code vulnerabilities are direct and easier to detect and there are many existing tools that can detect and assess vulnerabilities due to programming errors or other common causes. The vulnerability sub-score 1150 derived by the project-specific mathematical model differs from conventional assessments of code vulnerability by including factors for logic vulnerabilities which are more subtle and harder to detect than direct coding bugs, which can be easily detected and validated by straightforward testing. These logical vulnerabilities, discussed in greater detail above, may include potential vulnerabilities caused due to:
Complex computations,
Rounding errors,
Data conversion/serialization errors and differences, and
Silent memory corruption.

The intelligent discovery platform attempts to identify parts of the source code that have such silent vulnerabilities that may not work correctly after modernization. These are pieces of code which will pass basic testing, but will result in gradual creeping errors over a period of time. An important part of modernization is to ensure that the software components in a system do not have any publicly known vulnerabilities. Soteria connects to and identifies known cybersecurity vulnerabilities in well known vulnerability databases such as the CVE database. The vulnerability score component incorporates all the above factors to come up with a composite score that indicates the vulnerability risks with modernization. Selecting link 1155 may lead to presentation of the vulnerability interface presenting the code module with the greatest identified vulnerability factor, as described above.

Finally, the portability sub-score 1160 derived by the project-specific mathematical model may measure the cloud-readiness of the legacy software, highlighting potential issues in lift-and-shift and challenges for true modernization efforts. The portability sub-score 1160 provides an assessment of how portable the software business logic is from a modernization angle. The portability of the legacy software may be affected, for example, by binary dependencies, where dependency on binary tools that are present on the source platform may negatively affect the Portability sub-score 1160. For example, mainframe applications that use mainframe-specific tools and frameworks such as JCLs, SORT tools. The reason for this is that modernization requires replacing the functionality of these tools with equivalent ones in the modern platform.

Another portability factor may be if the applications rely on proprietary or platform-specific file formats (such as VSAM files), then this will increase the Portability sub-score 1160. Furthermore, if the application relies on proprietary protocols, such as custom on-the-wire protocols over raw sockets, then this decrease the portability and make modernization harder. Applications that use open protocols (SOAP, REST) are more portable, and accordingly have a lower portability sub-score 1160. Another portability factor may arise for applications that rely on native or platform-specific code, such as components implemented in low-level assembly or C. Such applications are harder to modernize due to the hardware and architecture differences between the legacy and modern platform. The portability score component uses these and other such criteria to calculate a score that indicates the modernization challenges. A high Portability score implies low cloud readiness and that it is harder to modernize the application. Selection of link 1165 may cause a portability interface to be displayed, where the factors described above are presented, and may be subsequently used to adapt the modernization process.

To compute the cumulative assessment score 1110, any suitable weighting of the sub-scores may be used. In an exemplary embodiment, the weighting may be done as follows:
S_{comp}—Composition score, W_{comp}—Composition weight
Sₑₘₚₗₓ—Complexity score, Wₑₘₚₗₓ—Complexity weight
S_{dep}—Dependency score, W_{dep}—Dependency weight
Sᵥᵤₗₙ—Vulnerability score, Wᵥᵤₗₙ—Vulnerability weight
Sₚₒᵣₜ—Portability score, Wₚₒᵣₜ—Portability weight
   The assessment score may then be determined by the below formula, which is the Kolmogorov mean of the individual scores:

$${S}_{overall} = {f}^{- 1} ( \frac{( {W}_{comp} {S}_{comp} ) + f ( {W}_{cmplx} {S}_{cmplx} ) + f ( {W}_{dep} {S}_{dep} ) + f ( {W}_{vuln} {S}_{vuln} ) + f ( {W}_{port} {S}_{port} )}{{W}_{comp} + {W}_{cmplx} + {W}_{dep} + {W}_{vuln} + {W}_{port}} )$$

The function ƒ as described above is a custom function that performs logarithmic scaling for compactification of the individual sub-scores.

The weight values W may be specific to a project and are chosen based on the knowledge base from the modernization platform. The analytics model can automatically assign an appropriate weight depending on user input and/or values derived iteratively over time. To better understand the score, the general guidelines in the exemplary embodiment shown are:
Score <50: Low complexity for modernization and easier to maintain. The average time to completion should be less than 6 months. Testing effort should be minimal. Code maintenance should be easier and self-explanatory. Easy integration with other modules.
Score between 50-65: Low to medium complexity for modernization. Efforts in testing are required. The average time to completion should be less than 12 months. Maintenance of the code would require additional training. Integration with other modules may require additional testing.
Score between 65-75: Medium to High complexity for modernization. High efforts in testing are required. The average time to completion should be less than 12-18 months. Maintenance of the code would require additional training. Integration with other modules may require additional testing.
Score >75: Very High complexity for modernization. Very High efforts in testing are required. The average time to completion should be less than 18-24 months. Maintenance of the code would require additional training. Integration with other modules may require additional testing.

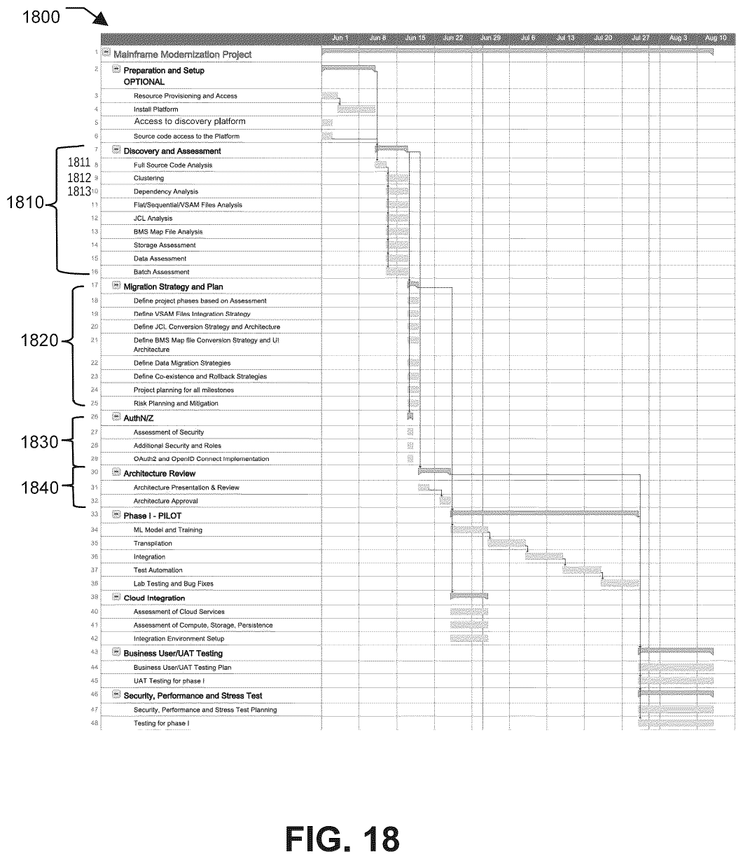

FIG. 18 illustrates an exemplary modernization plan 1800 derived using the determined modernization parameters, in an embodiment. As shown in modernization plan 1800, the report output by the intelligent discovery platform may be automatically fed directly to a modernization platform, which may parse and extract information for the report for use during modernization of the legacy software. Section 1810 of modernization plan details outputs of the intelligent discovery platform which may be provided to the modernization platform to assist in the modernization process. For example, the discovery platform identifies dependencies between various programs in the report in dependency analysis 1813; the modernization platform uses the dependency mapping during actual modernization to know which programs depend on which ones when formulating the migration strategy and plan 1820. The discovery platform report may also identify back end and re-usable modules and services as part of the dependency analysis 1813, which are appropriately modernized by the modernization platform into library dependencies or service dependencies.

Furthermore, the discovery platform may identify high-level “clusters” in the legacy software source code, which are groups of programs that have high density dependencies (multiple programs calling each other), in the clustering analysis portion 1812 of the report. This clustering analysis 1812 may be used by the modernization platform to identify the microservice architecture for the modernized application in the architecture review portion 1840 of the modernization plan. The clustering analysis 1812 may also identify dead code and modules in the source code, which helps the modernization platform architecture review portion 1840 flag those modules to ensure that they are not modernized. The discovery platform may also identify high-level software patterns in the source code (e.g., in the source code analysis section 1811 of the report), which may be used by the modernization platform to perform refactoring and avoid code duplication during modernization. Additional outputs from the report which may be provided as an input to the modernization platform may be identified business vulnerabilities, compliance issues and hotspots. As shown in section 1830, the modernization platform may include special logic to deal with security issues to ensure that the modernized code does not have foreseeable vulnerabilities. While several exemplary outputs of the discovery platform have been discussed here, numerous other outputs from the report may be used by the modernization platform, as is shown in exemplary modernization plan 1800.

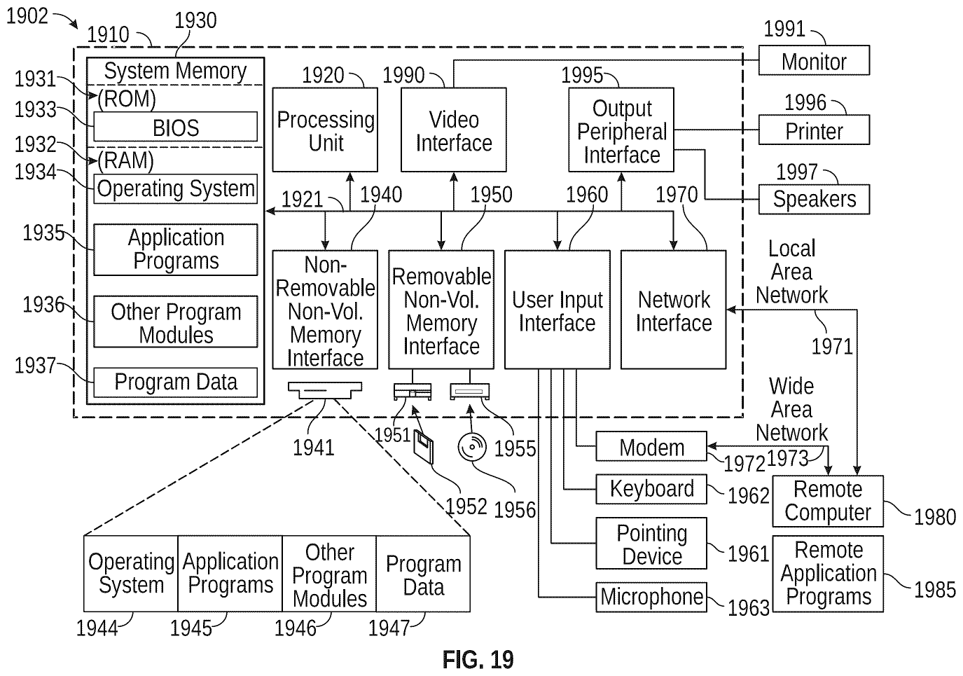

FIG. 19 depicts a block diagram illustrating an exemplary computing system 1900 for execution of the operations comprising various embodiments of the disclosure. The computing system 1902 is only one example of a suitable computing system, such as a mobile computing system, and is not intended to suggest any limitation as to the scope of use or functionality of the design. Neither should the computing system 1902 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 1902 may be implemented as a mobile computing system such as one that is configured to run with an operating system (e.g., iOS) developed by Apple Inc. of Cupertino, California or an operating system (e.g., Android) that is developed by Google Inc. of Mountain View, California.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

The computing system 1902 may include, but are not limited to, a processing unit 1920 having one or more processing cores, a system memory 1930, and a system bus 1921 that couples various system components including the system memory 1930 to the processing unit 1920. The system bus 1921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 1902 typically includes a variety of computer readable media. Computer readable media can be any available media that can be accessed by computing system 1902 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 1902. Communication media typically embodies computer readable instructions, data structures, or program modules.

The system memory 1930 may include computer storage media in the form of volatile and/or nonvolatile memory such as read only memory (ROM) 1931 and random access memory (RAM) 1932. A basic input/output system (BIOS) 1933, containing the basic routines that help to transfer information between elements within computing system 1902, such as during start-up, is typically stored in ROM 1931. RAM 1932 typically contains data and/or program modules that are immediately accessible to and/or presently being operated on by processing unit 1920. By way of example, and not limitation, FIG. 19 also illustrates operating system 1934, application programs 1935, other program modules 1936, and program data 1937.

The computing system 1902 may also include other removable/non-removable volatile/nonvolatile computer storage media. By way of example only, computing system 1902 also illustrates a hard disk drive 1941 that reads from or writes to non-removable, nonvolatile magnetic media, a magnetic disk drive 1951 that reads from or writes to a removable, nonvolatile magnetic disk 1952, and an optical disk drive 1955 that reads from or writes to a removable, nonvolatile optical disk 1956 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 1941 is typically connected to the system bus 1921 through a non-removable memory interface such as interface 1940, and magnetic disk drive 1951 and optical disk drive 1955 are typically connected to the system bus 1921 by a removable memory interface, such as interface 1950.

The drives and their associated computer storage media discussed above and illustrated in computing system 1902, provide storage of computer readable instructions, data structures, program modules and other data for the computing system 1902. In FIG. 19, for example, hard disk drive 1941 is illustrated as storing operating system 1944, application programs 1945, other program modules 1946, and program data 1947. Note that these components can either be the same as or different from operating system 1934, application programs 1935, other program modules 1936, and program data 1937. The operating system 1944, the application programs 1945, the other program modules 1946, and the program data 1947 are given different numeric identification here to illustrate that, at a minimum, they are different copies.

A user may enter commands and information into the computing system 1902 through input devices such as a keyboard 1962, a microphone 1963, and a pointing device 1961, such as a mouse, trackball or touchpad or touch screen. Other input devices (not shown) may include a joystick, gamepad, scanner, or the like. These and other input devices are often connected to the processing unit 1920 through a user input interface 1960 that is coupled with the system bus 1921, but may be connected by other interface and bus structures, such as a parallel port, game port or a universal serial bus (USB). A monitor 1991 or other type of display device is also connected to the system bus 1921 via an interface, such as a video interface 1990. In addition to the monitor, computers may also include other peripheral output devices such as speakers 1997 and printer 1996, which may be connected through an output peripheral interface 1990.

The computing system 1902 may operate in a networked environment using logical connections to one or more remote computers, such as a remote computer 1980. The remote computer 1980 may be a personal computer, a hand-held device, a server, a router, a network PC, a peer device or other common network node, and typically includes many or all of the elements described above relative to the computing system 1902. The logical connections depicted in computing system 1902 include a local area network (LAN) 1971 and a wide area network (WAN) 1973, but may also include other networks. Such networking environments are commonplace in offices, enterprise-wide computer networks, intranets and the Internet.

When used in a LAN networking environment, the computing system 1902 may be connected to the LAN 1971 through a network interface or adapter 1970. When used in a WAN networking environment, the computing system 1902 typically includes a modem 1972 or other means for establishing communications over the WAN 1973, such as the Internet. The modem 1972, which may be internal or external, may be connected to the system bus 1921 via the user-input interface 1960, or other appropriate mechanism. In a networked environment, program modules depicted relative to the computing system 1902, or portions thereof, may be stored in a remote memory storage device. By way of example, and not limitation, FIG. 5 illustrates remote application programs 1985 as residing on remote computer 1980. It will be appreciated that the network connections shown are exemplary and other means of establishing a communications link between the computers may be used.

It should be noted that some embodiments of the present invention may be carried out on a computing system such as that described with respect to computing system 1902. However, some embodiments of the present invention may be carried out on a server, a computer devoted to message handling, handheld devices, or on a distributed system in which different portions of the present design may be carried out on different parts of the distributed computing system.

Another device that may be coupled with the system bus 1921 is a power supply such as a battery or a Direct Current (DC) power supply) and Alternating Current (AC) adapter circuit. The DC power supply may be a battery, a fuel cell, or similar DC power source that needs to be recharged on a periodic basis. The communication module (or modem) 1972 may employ a Wireless Application Protocol (WAP) to establish a wireless communication channel. The communication module 1972 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method for modernizing software, the method comprising:
receiving, from an agent component executing on a client computing device, metadata regarding legacy software also executing on the client computing device, the metadata comprising a plurality of metrics describing a size, underlying file types, and underlying technologies used by the legacy software;
training a code classifier machine learning model to compute a plurality of score factors from a plurality of metrics received via software metadata, the code classifier machine learning model being trained using a knowledge base comprising predetermined score factors assigned to previously-performed software modernizations, the previously-performed software modernizations being performed on software having different sizes, underlying file types, and underlying technologies;
computing, by the trained code classifier machine learning model, a plurality of score factors associated with the legacy software based on the received metadata, the computing being performed in response to receiving the metadata regarding the legacy software;
deriving, by a project-specific model in communication with the trained code classifier machine learning model, a plurality of sub-scores based on the plurality of score factors associated with the legacy software, the plurality of sub-scores including sub-scores for complexity, dependency, and vulnerability;
identifying, using an analytics and reporting component, a code module having a greatest derived vulnerability score factor relative to other code modules;
generating a reconstructed representational snippet of original code based on metadata associated with the identified code module;
generating modern code corresponding to the representational snippet; and
generating a graphical interface including the reconstructed representational snippet, the generated modern code, and an automatically-generated explanation of vulnerabilities identified by the analytics and reporting component for the identified code module.

2. The method of claim 1, further comprising:
generating, by the analytics and reporting component, a cumulative report for the legacy software that includes interactive presentations of each of the sub-scores for composition, complexity, dependency, vulnerability, and portability; and
deriving, by the analytics and reporting component, a cumulative assessment score based on each of the composition, complexity, dependency, vulnerability, and portability sub-scores, the cumulative assessment score being included with the cumulative report on a dashboard interface.

3. The method of claim 2, further comprising determining file-specific complexity scores for each file included within the legacy software, the file-specific complexity scores being based on the file sizes, numbers of blank lines, and numbers of total lines of code of each file, the complexity sub-score for the legacy software being based on an aggregation of the file-specific complexity scores.

4. The method of claim 3, the cumulative report including a complexity graphical interface presenting each determined file-specific complexity score, wherein when an individual file is selected from the complexity graphical interface by user input, at least one of a dependency graph for related files, a variable graphical representation, a reconstructed representational snippet for the selected file, and a generated modern code equivalent for the reconstructed representational snippet is displayed in response to the user input selecting the individual file.

5. The method of claim 4, wherein, in response to the user input selecting the individual file, at least one of an interactive data flow diagram or a summary of code vulnerabilities detected within the selected file is further displayed, the interactive data flow diagram illustrating connections between code portions of the selected file and being filterable in response to user selection of different types of code portions.

6. The method of claim 1, further comprising:
generating an interactive dependency graph including representations of every file in the legacy software as nodes and links between the files based on data flows between the files as lines, the interactive dependency graph being sortable based on file type;
receiving a selection by the user on one of the nodes;
receiving a user input dragging the selected node on the interactive dependency graph; and
in response to receiving the dragging user input, moving the node and any connected nodes across the interactive dependency graph in a direction of the dragging user input, where any nodes not connected to the selected node remain in place on the interactive dependency graph.

7. The method of claim 1, further comprising separately executing the representational snippet and the generated modern code in response to a request by the user to execute the identified code module, and displaying outputs generated by both the representational snippet and the generated modern code, the outputs being different.

8. The method of claim 7, further comprising:
requesting, by the analytics and reporting component, an augmented version of the generated modern code that is modified to account for differences between the legacy software and modern software platforms;
replacing the generated modern code with the augmented version in response to a user request to fix the generated modern code;
separately executing the representational snippet and the augmented version in response to a second request by the user to execute the identified code module; and
displaying outputs generated by both the representational snippet and augmented version, the outputs being more similar than the outputs generated by the representational snippet and the generated modern code.

9. A computer program product comprising computer-readable program code to be executed by one or more processors when retrieved from a non-transitory computer-readable medium, the program code including instructions to:
receive metadata regarding legacy software also executing on the client computing device, the metadata comprising a plurality of metrics describing a size, underlying file types, and underlying technologies used by the legacy software;
train a code classifier machine learning model to compute a plurality of score factors from a plurality of metrics received via software metadata, the code classifier machine learning model being trained using a knowledge base comprising predetermined score factors assigned to previously-performed software modernizations, the previously-performed software modernizations being performed on software having different sizes, underlying file types, and underlying technologies;
compute, by the trained code classifier machine learning model, a plurality of score factors associated with the legacy software based on the received metadata, the computing being performed in response to receiving the metadata regarding the legacy software;
derive, by a project-specific model in communication with the trained code classifier machine learning model, a plurality of sub-scores based on the plurality of score factors associated with the legacy software, the plurality of sub-scores including sub-scores for complexity, dependency, and vulnerability;
identify, using an analytics and reporting component, a code module having a greatest derived vulnerability score factor relative to other code modules;
generate a reconstructed representational snippet of original code based on metadata associated with the identified code module;
generate modern code corresponding to the representational snippet; and
generate a graphical interface including the reconstructed representational snippet, the generated modern code, and an automatically-generated explanation of vulnerabilities identified by the analytics and reporting component for the identified code module.

10. The computer program product of claim 9, the program code including instructions to:
generate, by the analytics and reporting component, a cumulative report for the legacy software that includes interactive presentations of each of the sub-scores for composition, complexity, dependency, vulnerability, and portability; and
derive, by the analytics and reporting component, a cumulative assessment score based on each of the composition, complexity, dependency, vulnerability, and portability sub-scores, the cumulative assessment score being included with the cumulative report on a dashboard interface.

11. The computer program product of claim 10, the program code including instructions to:
determine file-specific complexity scores for each file included within the legacy software, the file-specific complexity scores being based on the file sizes, numbers of blank lines, and numbers of total lines of code of each file, the complexity sub-score for the legacy software being based on an aggregation of the file-specific complexity scores; and
generate a complexity graphical interface presenting each determined file-specific complexity score, wherein when an individual file is selected from the complexity graphical interface by user input, at least one of a dependency graph for related files, a variable graphical representation, a reconstructed representational snippet for the selected file, and a generated modern code equivalent for the reconstructed representational snippet is displayed in response to the user input selecting the individual file.

12. The computer program product of claim 9, the program code including instructions to:
generate an interactive dependency graph including representations of every file in the legacy software as nodes and links between the files based on data flows between the files as lines, the interactive dependency graph being sortable based on file type;
receive a selection by the user on one of the nodes;
receive a user input dragging the selected node on the interactive dependency graph; and
in response to receiving the dragging user input, move the node and any connected nodes across the interactive dependency graph in a direction of the dragging user input, where any nodes not connected to the selected node remain in place on the interactive dependency graph.

13. The computer program product of claim 9, the program code including instructions to separately execute the representational snippet and the generated modern code in response to a request by the user to execute the identified code module, and display outputs generated by both the representational snippet and the generated modern code, the outputs being different.

14. The computer program product of claim 13, the program code including instructions to:
request, by the analytics and reporting component, an augmented version of the generated modern code that is modified to account for differences between the legacy software and modern software platforms;
replace the generated modern code with the augmented version in response to a user request to fix the generated modern code;
separately execute the representational snippet and the augmented version in response to a second request by the user to execute the identified code module; and
display outputs generated by both the representational snippet and augmented version, the outputs being more similar than the outputs generated by the representational snippet and the generated modern code.

15. A system for modernizing software, the system comprising:
one or more processors; and
a non-transitory computer readable medium storing a plurality of instructions, which when executed, cause the one or more processors to:
receive metadata regarding legacy software also executing on the client computing device, the metadata comprising a plurality of metrics describing a size, underlying file types, and underlying technologies used by the legacy software;
train a code classifier machine learning model to compute a plurality of score factors from a plurality of metrics received via software metadata, the code classifier machine learning model being trained using a knowledge base comprising predetermined score factors assigned to previously-performed software modernizations, the previously-performed software modernizations being performed on software having different sizes, underlying file types, and underlying technologies;
compute, by the trained code classifier machine learning model, a plurality of score factors associated with the legacy software based on the received metadata, the computing being performed in response to receiving the metadata regarding the legacy software;
derive, by a project-specific model in communication with the trained code classifier machine learning model, a plurality of sub-scores based on the plurality of score factors associated with the legacy software, the plurality of sub-scores including sub-scores for complexity, dependency, and vulnerability;
identify, using an analytics and reporting component, a code module having a greatest derived vulnerability score factor relative to other code modules;
generate a reconstructed representational snippet of original code based on metadata associated with the identified code module;
generate modern code corresponding to the representational snippet; and
generate a graphical interface including the reconstructed representational snippet, the generated modern code, and an automatically-generated explanation of vulnerabilities identified by the analytics and reporting component for the identified code module.

16. The system of claim 15, the instructions further causing the one or more processors to:
generate, by the analytics and reporting component, a cumulative report for the legacy software that includes interactive presentations of each of the sub-scores for composition, complexity, dependency, vulnerability, and portability; and
derive, by the analytics and reporting component, a cumulative assessment score based on each of the composition, complexity, dependency, vulnerability, and portability sub-scores, the cumulative assessment score being included with the cumulative report on a dashboard interface.

17. The system of claim 16, the instructions further causing the one or more processors to:
determine file-specific complexity scores for each file included within the legacy software, the file-specific complexity scores being based on the file sizes, numbers of blank lines, and numbers of total lines of code of each file, the complexity sub-score for the legacy software being based on an aggregation of the file-specific complexity scores; and
generate a complexity graphical interface presenting each determined file-specific complexity score, wherein when an individual file is selected from the complexity graphical interface by user input, at least one of a dependency graph for related files, a variable graphical representation, a reconstructed representational snippet for the selected file, and a generated modern code equivalent for the reconstructed representational snippet is displayed in response to the user input selecting the individual file.

18. The system of claim 15, the instructions further causing the one or more processors to:
generate an interactive dependency graph including representations of every file in the legacy software as nodes and links between the files based on data flows between the files as lines, the interactive dependency graph being sortable based on file type;
receive a selection by the user on one of the nodes;
receive a user input dragging the selected node on the interactive dependency graph; and
in response to receiving the dragging user input, move the node and any connected nodes across the interactive dependency graph in a direction of the dragging user input, where any nodes not connected to the selected node remain in place on the interactive dependency graph.

19. The system of claim 15, the instructions further causing the one or more processors to separately execute the representational snippet and the generated modern code in response to a request by the user to execute the identified code module, and display outputs generated by both the representational snippet and the generated modern code, the outputs being different.

20. The system of claim 19, the instructions further causing the one or more processors to:
request, by the analytics and reporting component, an augmented version of the generated modern code that is modified to account for differences between the legacy software and modern software platforms;
replace the generated modern code with the augmented version in response to a user request to fix the generated modern code;
separately execute the representational snippet and the augmented version in response to a second request by the user to execute the identified code module; and
display outputs generated by both the representational snippet and augmented version, the outputs being more similar than the outputs generated by the representational snippet and the generated modern code.
